(19) United States
(12) Patent Application Publication
(10) Pub. No.: US 2005/0021342 A1
(43) Pub. Date: Jan. 27, 2005

(54) Language recognizer and operating method therefor

(76) Inventors: Andreas Ralph Major, Petershausen (DE); Michael Wandinger, Munchen (DE)

Correspondence Address: BELL, BOYD & LLOYD, LLC, P. O. BOX 1135, CHICAGO, IL, 60690-1135, US

(21) Appl. No.: 10/501,857

(22) PCT Filed: Jan. 2, 2003
(86) PCT No.: PCT/EP03/00005

(30) Foreign Application Priority Data
Jan. 17, 2002 (EP) 02001255.5

(51) Int. Cl. G10L 11/00

(52) U.S. Cl. 704/275

(57) ABSTRACT

Disclosed is a language recognition apparatus having a storage with a stored vocabulary of words to be recognized for the language-based controlling of programs and/or other files. A word of the vocabulary is assigned to each program and/or file. A link is stored in a file directory for each program or file, and the names of the links form a first active partial vocabulary of the language recognition apparatus. Also disclosed is methods of operating the language recognition apparatus including providing a language recognition apparatus, for example, as described above, and generating a current vocabulary containing at least the names of the links from the file directory when a voice recognition program configured to perform voice recognition is started.

### BACKGROUND

The present disclosures relate to a voice recognizer that stores a vocabulary of words to be recognized for voice control of a plurality of programs and/or other files, each of which is assigned a word of the vocabulary as a name.

Having long secured itself a permanent and constantly growing application area in the input of text to office applications running on PCs, voice recognition is also making increasing inroads in the control of technical devices. Both in ultra-miniaturized and at the same time computerized hand-held electronic devices, particularly mobile phones and PDAs, and in technical devices that are meant to involve minimum attention and concentration from the user to operate, such as the various technical devices in a moving car, this type of voice recognition together with voice control based thereon can find useful potential applications. In the former type of devices, the area available for control actions has actually become so small that the numerous possible functions can only be implemented very inconveniently using traditional keypad or touch-screen entries, and almost not at all for people with poor sight. In areas of use in which the attention of the user must remain focused on other things, for example road traffic, the introduction of voice control not only increases convenience but greatly improves safety.

In voice recognition, a lexicon containing the words to be recognized is required. In the case of phoneme-based voice recognition, these words are transferred by means of a text-to-phoneme technique into a phonetic transcription and saved in the vocabulary. During the recognition process, a search for the best path through the phoneme strings contained in the vocabulary is made using the Viterbi algorithm as it is known. Details of the established voice recognition algorithms are given in the relevant technical literature.

Highly computerized technical devices of the aforementioned type, for example PDAs, hand-held PCs, mobile phones, vehicle audio systems, on-board computers, etc., have user-interfaces or MMI structures that are derived from PC user interfaces. There are a large number of applications installed that need to be controlled in a suitable way, and also in more complex devices in a specific sub-level of a logical hierarchy. In traditional devices of this type, menu-based control is provided for this purpose that can be executed by the user using soft-key entries.

When selecting an application by voice input, the program names of the available applications are contained in the lexicon. Once a name is recognized, the relevant program is executed or the application started. To do this, the program name and the program path must be saved in a suitable format.

According to the state of the art, the individual program names are hard-wired to the corresponding recognition results (the words in the lexicon). This can be specified in an additional file, or permanently defined in the source code of the program. Both methods have disadvantages, which are described below.

One disadvantage is that when working with an additional file there is the problem that it can be seen by the user and consequently can also be modified. Even binary formats or write-protected files offer no effective protection against changes. This can lead to discrepancies between the vocabulary used and the word list or program list, with the consequence that the application may respond incorrectly.

Another disadvantage is that when the voice expressions acting as control commands are defined in the source code, it is not easy to make further changes to the vocabulary. The source code would need to be re-compiled and shipped every time changes in the program names occurred.

Additionally, a further disadvantage of the technique used up to now is the non-existent or inadequate system expandability. At present, it is not possible for the user to record his own commands or applications for inclusion in the automatic voice recognition, at least not without the risk of a fault in the originally programmed configuration of the voice recognizer.

### SUMMARY OF THE INVENTION

The present disclosure provides an improved voice recognizer and methods for its operation with which the device can be configured more flexibly in order to include the user's own control commands or applications.

As an example, an apparatus for voice recognition is provided including a storage having a stored vocabulary of words to be recognized for voice control of a plurality of programs and other files, wherein each of the plurality of programs and other files is assigned a word of the vocabulary as a name. The apparatus also includes a file directory configured to store a link to each program and file of the plurality of programs and other files, wherein the names of the links form a first active partial vocabulary of the voice recognition apparatus.

As another example, a voice recognition method is provided comprising providing a voice recognition apparatus, for example, as described above, and generating a current vocabulary containing at least the names of the links from the file directory when a voice recognizer program configured to perform voice recognition is started.

### DETAILED DESCRIPTION OF THE PRESENT EXAMPLES

The presently disclosed apparatus and methods incorporate the fundamental idea of providing a user interface constructed using links for the voice control of applications or for suitable handling of files. The organization principle of the links enables programs or files in different hierarchy levels to be opened easily in a structured way without a rigid assignment needing to be defined and programmed in advance.

The list of words to be recognized (the lexicon) is defined by the contents of a specific file directory which contains links (shortcuts) to the programs or files present. The name of the link specifies the word to be recognized, and the program or file to which this link points specifies the action to be performed. In converting the name, one should note that only the partial string in front of the first dot is used as a command. The vocabulary is generated when the recognizer program is started. This allows a flexible response to changes in the application structure or file structure. As soon as a word is recognized, the relevant link is actuated and the required action executed.

Advantages compared with previous techniques include flexibility regarding words and actions, and the simple creation and modification of a complex recognizer vocabulary. New commands can be added to the existing vocabulary in a simple and familiar way. A shortcut to the required program or file merely needs to be created in the file directory. Under Windows, for example, a shortcut can be created easily via the context menu.

A further advantage of the presently disclosed apparatus and methods is that the file system takes over the management of commands and actions (name and destination of the shortcut), and, therefore, no additional program is required for managing the vocabulary. If a command is meant to be deleted, the link is simply deleted.

Since modern operating systems allow links to files as well, documents can also be opened by voice command.

In an example, the file directory includes a plurality of sub-directories in at least one subordinate hierarchy level, the directory names forming a first and, if applicable, further, active partial vocabularies of the voice recognizer lower down the hierarchy.

By using sub-directories in the file directory, structured voice commands to open programs and files can be generated in the simplest way. For instance, all links to pieces of music are saved in a sub-directory “music”. The word “music” is held in the active vocabulary in the first stage of recognition. If it is recognized, the vocabulary is switched (e.g., by language model), and the links contained in the “music” sub-directory are now held in the active vocabulary.

In particular, each program or file is assigned from a sub-directory a voice command having multiple connected parts that contains the names of the links from the file directory and each subordinate sub-directory leading to the program or file.

Complex voice commands can be created and edited in the simplest way using this method. Existing directories containing shortcuts, such as the Windows start menu, can now be operated simply by voice control because all necessary information is already there.

This method is a further development of shortcuts to programs, for example, Windows PC, and the hard-wired voice recognizer resources. In this method the recognizer resource is provided automatically by the creation of a link, i.e. the name of the link can be processed by the recognizer immediately afterwards.

In general, any files and programs can be opened by voice command once they have been copied into the special directory. It also makes no difference whether a music title, c++file, text document or program is involved. By saving a link in the special directory, the file is opened by the default program configured. For example, a document with the .doc extension is opened automatically by the Word program (as when double clicking on the file in traditional PC entry).

The aspects of the above disclosure appear as both apparatus aspects of a voice recognizer and as aspects of an operating method thereof, particularly since it is typically implemented in a suitable mix of hardware and software components.

Two ways of recording a word in the recognizer lexicon are described as follows. The first way is recording by a program call via the context menu for the required application. In this case the context menu contains two program calls (e.g., Add and Remove). Add adds the relevant program/file and Remove displays the list of programs/files that can currently be selected by voice selection. The second way is to use a “drag'n'drop” procedure to copy the link to the required application into the special folder. In this case, in order to remove a program, one must switch to the relevant directory and delete the required link from the directory by “deleting”.

It should be understood that various changes and modifications to the presently preferred examples described herein will be apparent to those skilled in the art. Such changes and modifications can be made without departing from the spirit and scope of the present invention and without diminishing its intended advantages. It is therefore intended that such changes and modifications be covered by the appended claims.

1. A voice recognizer having a stored vocabulary of words to be recognized for voice control of a plurality of programs and/or other files, each of which are assigned a word of the vocabulary as name, wherein
a link to each program or file is saved in a file directory, the names of the links forming a first active partial vocabulary of the voice recognizer.

2. The voice recognizer as claimed in claim 1, wherein
the names of the links are formed by voice commands and the links define shortcuts to application programs.

3. The voice recognizer as claimed in claim 1, wherein
the names of the links are formed by voice commands and the links define shortcuts to documents, in particular text documents or voice, music or video files.

4. The voice recognizer as claimed in one of the preceding claims, wherein
the file directory contains a plurality of sub-directories in at least one subordinate hierarchy level, the names of the sub-directories together with those of the links forming a first and if applicable further, active partial vocabularies of the voice recognizer lower down the hierarchy.

5. The voice recognizer as claimed in claim 4, wherein
each program or file is assigned from a sub-directory a voice command composed of multiple connected parts that contains the names of the links from the file directory and each subordinate sub-directory leading to the program or file.

6. An operating method for a voice recognizer as claimed in one of the preceding claims, wherein
the current vocabulary containing at least the names of the links from the file directory is generated when the voice recognizer program is started.

7. The operating method as claimed in claim 6, wherein
the administration of the vocabulary is effected as management of the file directory and optionally present sub-directories without an additional vocabulary management program.

8. The operating method as claimed in claim 6 or 7, wherein
in order to edit voice commands composed of multiple connected parts, sub-directories are created below the file directory in at least one subordinate hierarchy level, and voice commands composed of multiple connected parts are recognized in a multi-stage recognition process, in the course of which a switch is made from a first into a second active partial vocabulary and if applicable further active partial vocabularies.

8. The operating method as claimed in one of the claims 6 to 8, wherein
the recording of new words in the vocabulary or the removal of words from the vocabulary is effected by a program call via a context menu for the relevant program or file known in the art or by a “drag'n'drop” procedure.
